(19) United States
(12) Patent Application Publication
(10) Pub. No.: US 2019/0355224 A1
(43) Pub. Date: Nov. 21, 2019

(54) Cash prompt smart register

(71) Applicant: Adeniyi Toriola, Bronx, NY (US)

(72) Inventor: Adeniyi Toriola, Bronx, NY (US)

(21) Appl. No.: 15/719,874

(22) Filed: May 21, 2018

(51) Int. Cl. G07G 1/12; G07G 1/00; G07G 1/06

(52) U.S. Cl. CPC G07G 1/12; G07G 1/06; G07G 1/0027

(57) ABSTRACT

The purpose of this invention is to make cash register transaction faster and lessen the work of a cashier. In order for this transaction to be faster the cash register counts the change for the cashier after the insertion of the money. The other concept to the smart register is that its built to restrict access to the safe or vault or the old drawer thereby preventing theft from the cashier or in the event of a robbery. Access is only given to whoever is in charge of the register like a supervisor through a combination lock to the safe. The third concept is the voice prompt where by the machine reads out the name of the item being scanned and the amount of money being inserted and dispensed. The fourth concept is that the pictures of the items will be appearing on the screen.

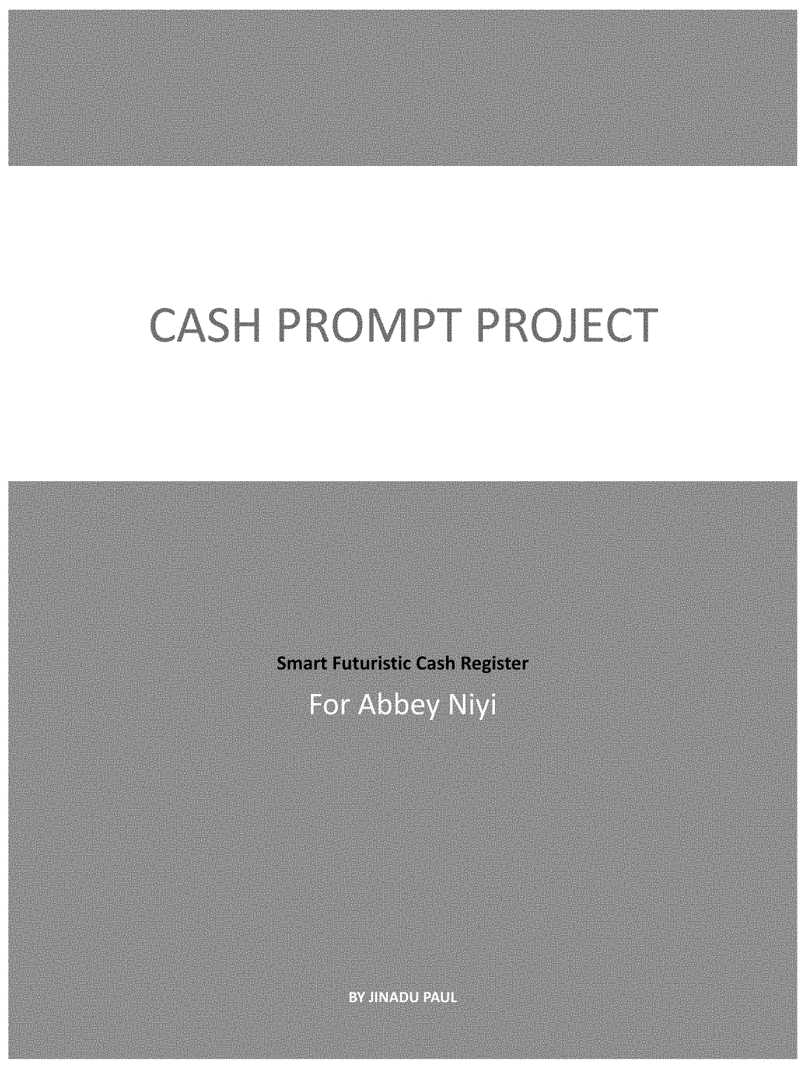

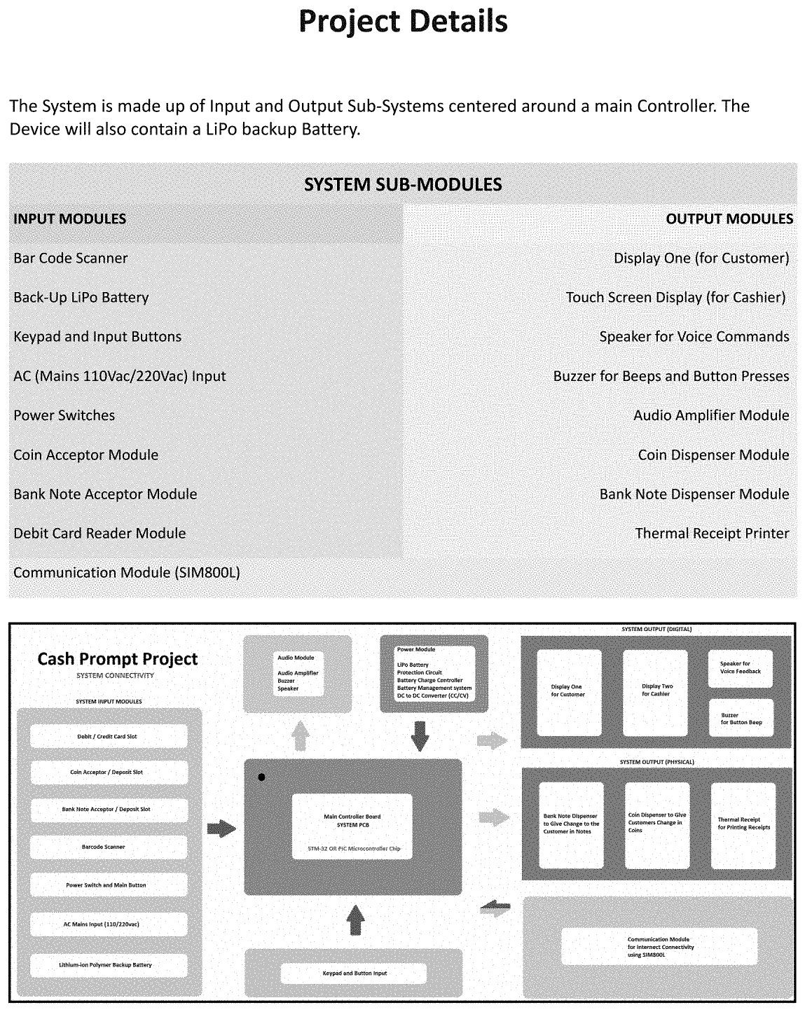

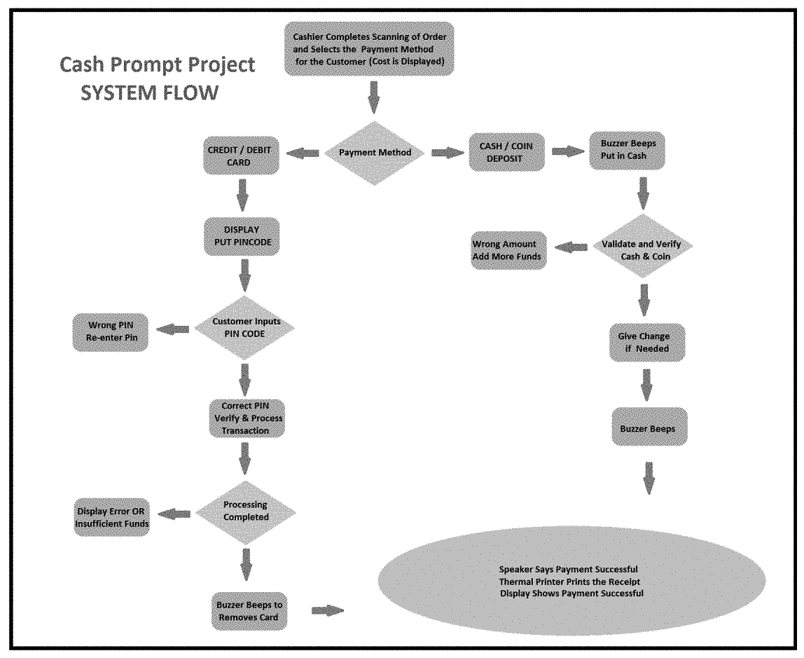

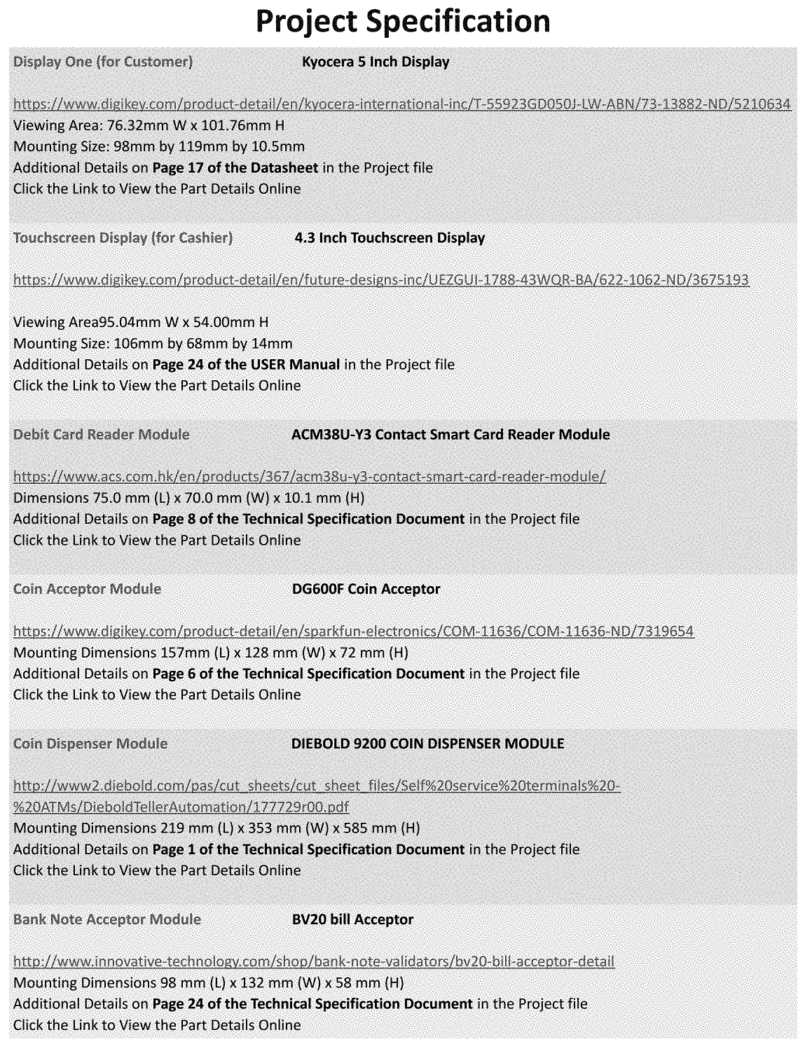

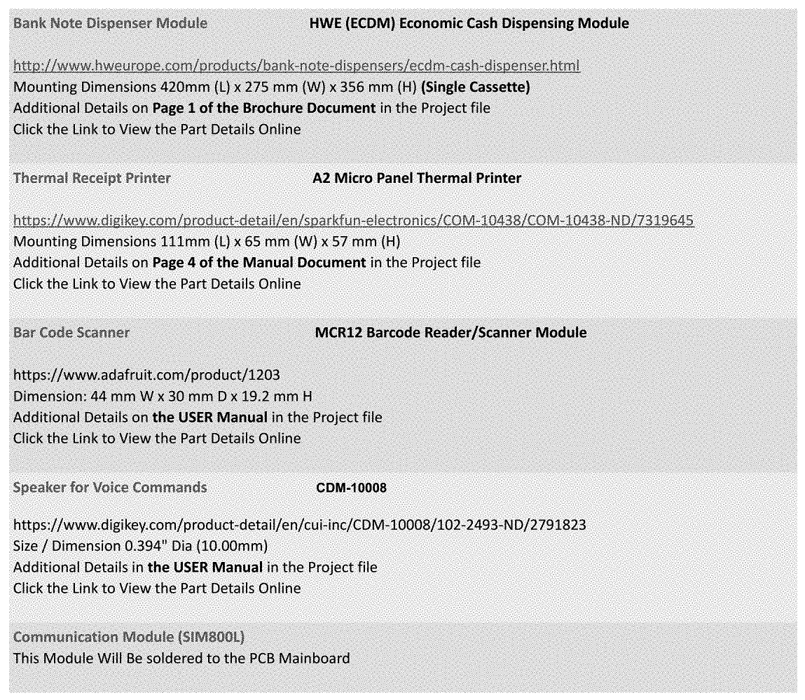

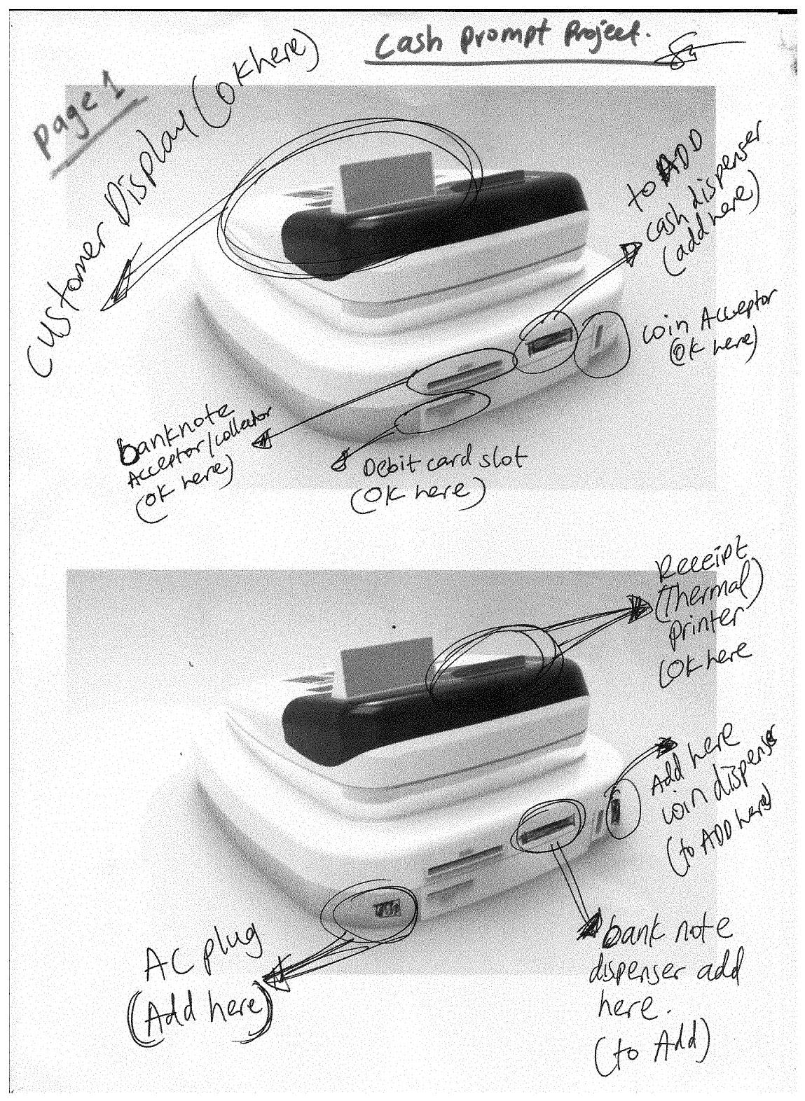

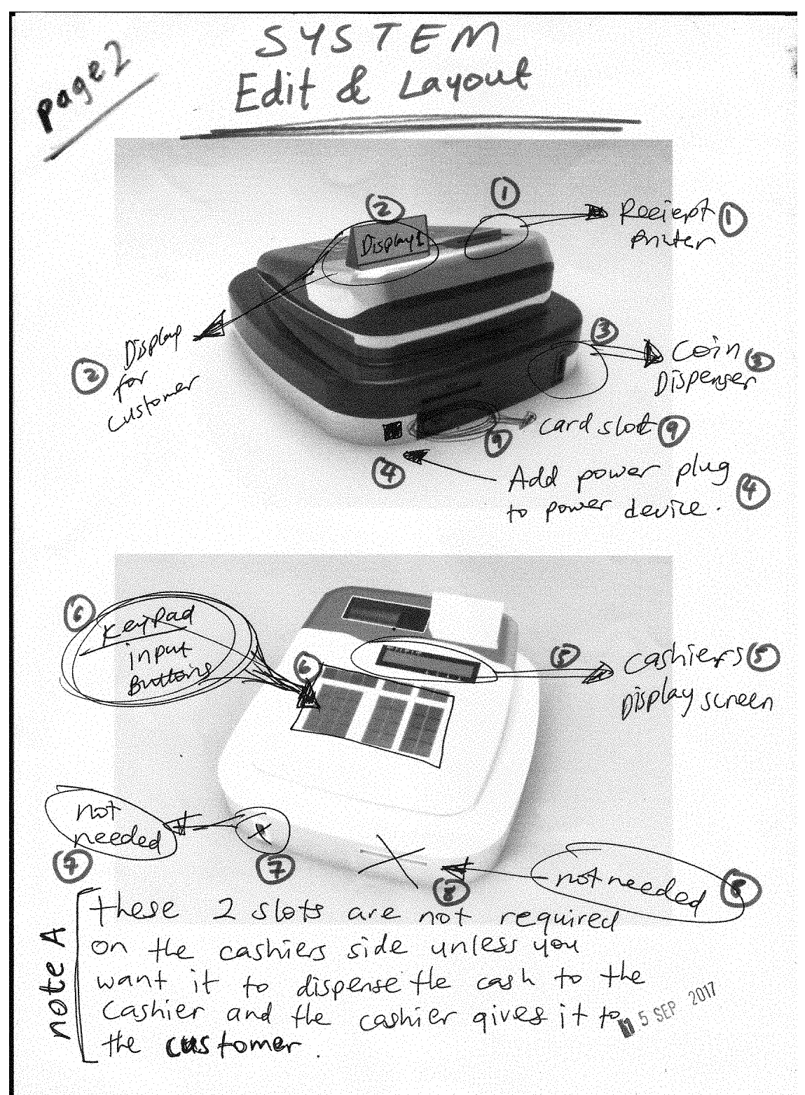

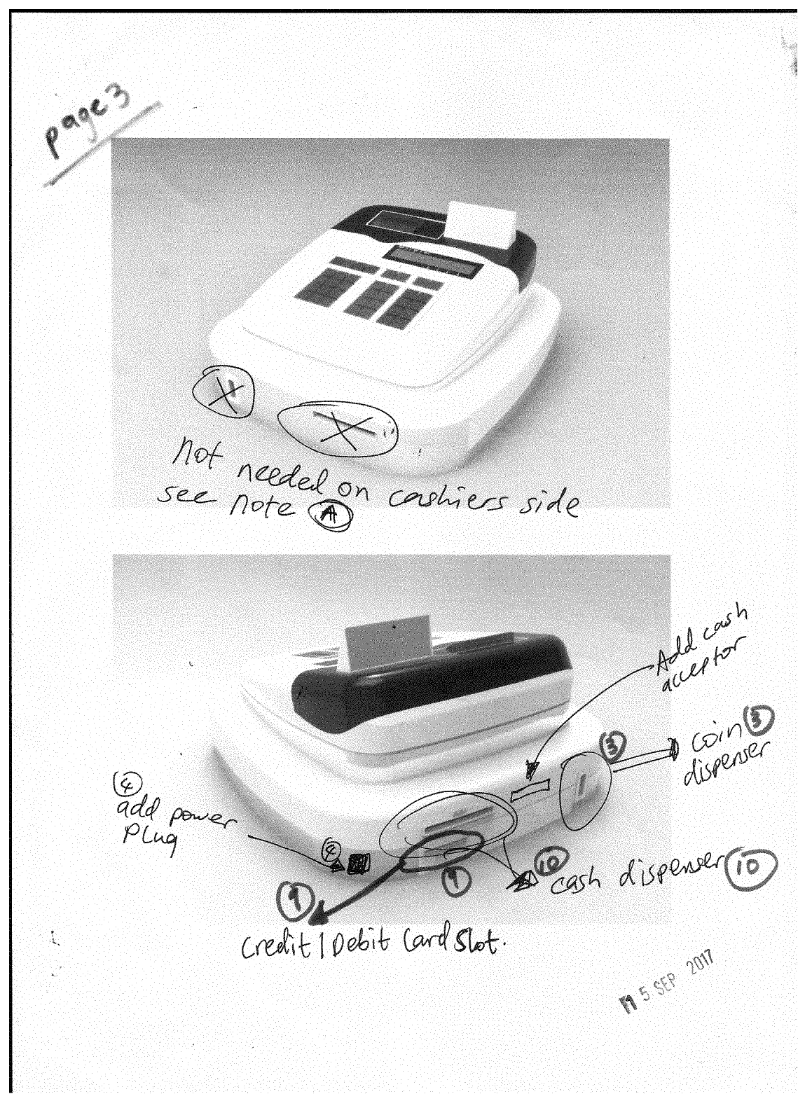

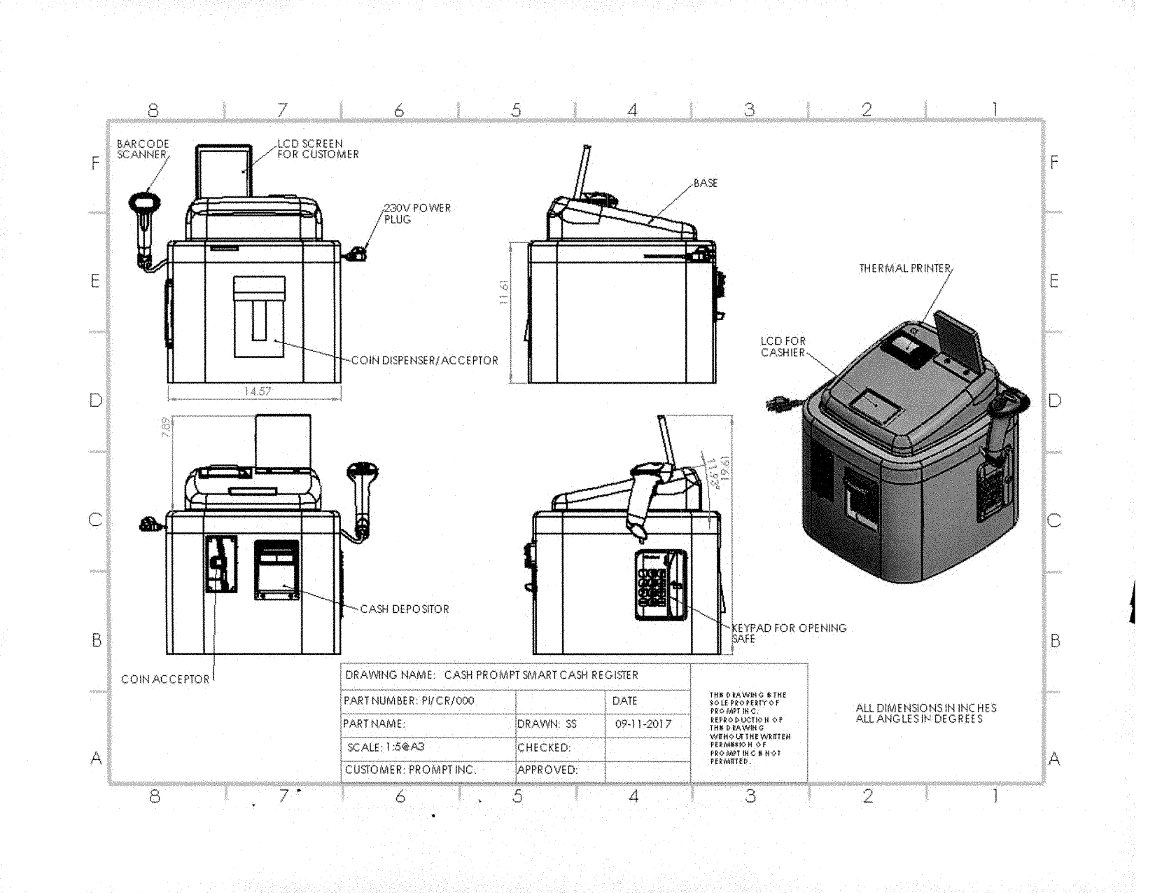

Cashiers can no longer have access to the register, the bank is inserted by the supervisor into the cash register.

This helps prevent theft from cashier and saves corporations a lot of money. This helps prevent theft from either the cashier and the customer. The machine reads out the amount, through it voice prompt.

The customer gives the money to the cashier and the cashier then takes the money and inserts it.

The customer receives the change by their selves from the back of the register that way the cashier doesn't touch it.

Although the change is shown on the screen, the cashier does not have to count the change thereby making a mistake and giving the wrong amount. The machine counts the change and dispenses the exact change.

Color:

The color of this cash registers is going to be gold, silver, white.

Additional Features

The register reads out the name of each item being scanned i.e milk duds is read out loud for brief description and if more than once it reads out the amount of times the item is being scanned or barcoded.

As items are being read out, depending on how fast the cashier is, the register can be reading out the previous item already being scanned and its ok for the delay of pronounciation or in short form for example duds instead milk duds.

Second additional features.

Picture of item to appear on screen.

Credit card slot will also be included.

There should be coin dispenser as well.

### BRIEF DESCRIPTION OF DRAWING

This first step of this device is the scanning of item with the barcode scanner and the item and its price, picture appears on the LCD screen after which the money is being inserted in the cash depositor then it goes in the machines base and shuffles around, then calculate the exact amount by subtracting the actual money inserted with the price of the item. Then the change comes out from the cash dispenser.

And also if there was any coin it will come out from the coin dispenser.

After the change has been dispensed the printer prints the receipt.

And also there is a keypad that is used for opening the safe

The Base is where all the processing of the money goes on.

### SUMMARY OF INVENTION

There is a current invention that has some of the similarities this has, its called the self checkout but there so many differences e.g that invention is too bulky and they are used in large supermarket only but my invention is going to be a general invention which could be used any store. For example the other invention cant be used in a drive through, at the club because you still need bartenders to serve drinks, also in box offices and concession stands. Basically my invention is for places that cashiers are still needed. Other differences mine possess is that it has voice prompt basically reading the names of the items aloud and also money being inserted. This invention is also smaller in size. And I came up with this idea because I worked as a cashier for 3 years, and I know a lot of cashier steal from the old cash registers drawer. Secondly I was at a grocery store and I saw there was a long line and the cashier couldn't keep up with scanning the Items and counting the money.

1. A smart cash register comprising a base, said base housing various electronic components of a proper functioning cash register, said base containing an LCD screen for a consumer and another LCD screen for a cashier; wherein a top surface of said base slopes at an angle toward said cashier, such that a side of said base facing said consumer is taller than side of the base facing said cashier; wherein said another LCD screen for said easier is embedded within said top surface substantially parallel with said top surface; wherein said LCD screen for said consumer being positioned on said top surface along said side facing said consumer and substantially perpendicular to said top surface and wherein a display area of said LCD screen for said consumer facing toward said consumer, wherein said sloping top surface causing said display area of said LCD screen for said consumer to be inclined upward toward said consumer; a vault, said vault having four walls and a bottom surface, said bottom surface disposed along the lower edge of said four walls; wherein said base forming a top wall of said vault; wherein said four walls, said bottom surface and said base forming a cube-like vault; a cash depositor, said cash depositor capable of accepting paper money disposed on a wall of said vault that is facing said cashier; a coin acceptor, said coin acceptor being disposed along same wall of said vault as having said cash depositor; wherein said base announcing an amount of money being inserted into said cash depositor and said coin acceptor; a coin dispenser, said coin dispenser disposed along a wall of said vault that is parallel to said wall having said cash depositor and said coin acceptor, such that said coin dispenser dispensing money due to consumer along said side facing said consumer; a keypad, said keypad disposed on one of said walls of said vault said keypad preventing granting access to money inside said vault only to a person having a correct button code sequence; wherein said keypad also functioning as credit card reader; a cradle for scanner protruding from one of said walls of said vault, said cradle holding a barcode scanner; wherein a light beam of said barcode scanner substantially oriented toward a side facing said consumer, said barcode scanner receiving electrical power from said base or said money storage container through said cradle; a retractable power cord, said retractable power cord extending from a slot along one of said walls of said vault, said retractable power cord capable of coupling with an electrical socket to power said LCD screen for said consumer, said LCD screen for said cashier, said cash depositor, said coin acceptor, said coin dispenser, said keypad, said barcode scanner, said base and said thermal printer; and wherein a spool for said thermal printer being mounted on said top surface adjacent to said LCD screen for said consumer.

2. (canceled)

3. (canceled)

4. (canceled)

5. (canceled)

6. The smart cash register of claim 1 wherein said LCD screen for the cashier shows the item quantity and cost.

7. The smart cash register of claim 1 wherein said LCD screen for the consumer capable of showing critical information comprising a group of an item, quantities cost, expiry date, total bill and a picture of the item or any combination thereof.

8. (canceled)

9. (canceled)

10. (canceled)

11. The smart cash register of claim 1, wherein a length of each said wall of said vault being between 14 and 15 inches; wherein a height of each said wall of said vault being between 11 and 12 inches; wherein said height not including a height of said base; and wherein a total height comprising of said height of one of each said wall and a height of said base and a height of said LCD for said consumer combining to be between 19 and 20 inches.
